(19) United States
(12) Patent Application Publication
(10) Pub. No.: US 2006/0248351 A1
(43) Pub. Date: Nov. 2, 2006

(54) METHOD AND APPARATUS FOR BUILDING SOFTWARE APPLICATIONS

(76) Inventors: DAVID BOOZ, Poughkeepsie, NY (US); Graham Charters, Southampton (GB); Mandy Chessell, Alton (GB); Ian Robinson, Southampton (GB)

Correspondence Address: IBM CORPORATION;INTELLECTUAL PROPERTY LAW, 11400 BURNET ROAD, AUSTIN, TX, 78758, US

(21) Appl. No.: 11/279,700

(22) Filed: May 9, 2006

(30) Foreign Application Priority Data
Apr. 27, 2005 (GB) 0508538.6

(51) Int. Cl. G06F 12/14

(52) U.S. Cl. 713/189

(57) ABSTRACT

A method and apparatus is disclosed for determining transaction attributes for software components which provide transaction data for the component itself and for any client of the component. The transaction attributes may be used for testing during component assembly and may be translated into transaction attributes of alternative runtime platforms.

### FIELD OF INVENTION

The present invention relates to a method and apparatus for building software applications. More particularly, but not exclusively, the present invention relates to providing software components that enable more efficient building of transactional processing software applications.

### BACKGROUND OF THE INVENTION

Application programs are commonly built using software development tools, also known as development environments. Using these tools, engineers can select components with appropriate functionality from a library of ready made components, or may also create components. The components are then assembled to provide an application program with the desired functionality. The application program can then be deployed in an appropriate execution environment.

Some such components require transactional processing to ensure the integrity of their processing. In transactional processing a set of operations are grouped together in a transaction and the progress of the transaction is recorded. In the event of failure in the processing of a transaction a procedure called rollback is carried out to return the processed data to the state prior to the processing of the failed transaction. In this manner a transaction is guaranteed to either succeed completely or to fail without consequence.

One of the challenges when assembling a program from components is ensuring that the components interact in a desired manner. Components that require transactional processing introduce an additional layer of complexity because the scope of a transaction affects the integrity and visibility of the business data. Transactional scope is defined as a flow of execution that occurs between the start and end of an atomic transaction. As a result, application designs must consider transactional scope within the context of component interactions. For example, two different components which extract data from a transaction capable resource manager (such as a database) may need a transaction to be active when they are called because each of the components expects its collective reads and updates to be atomic within the database. When these components are assembled into an application, the engineer that assembles the application has to decide whether those two components should run in the same transaction or in different transactions. The correct answer depends on the intended behavior of the application as well as how each component has been coded. The application design may require that each component's reads and updates should occur independently with respect to other components in the system. Alternatively, the collective accesses from both components may be highly interdependent. As a result, both components must run under the same transaction. When the interactions of more than two components are considered, the possible interactions become more complex.

Examples of application environments which enable the construction of application programs which utilize transaction processing are J2EE™ from SUN Microsystems™ and .Net™ from Microsoft Corporation™. In a J2EE based system the declaration of required transactional semantics are defined in deployment descriptors and added to the application as the components are assembled. In the .Net system the transaction attributes are specified in the component implementation.

One problem with existing application environments is that components transactional requirements are difficult to determine when components are assembled into an application.

### SUMMARY OF THE INVENTION

Some embodiments provide a software component for assembly with one or more other components into a transactional application program, the software component comprising:

a first identifier for indicating whether the component executes in a global or a local transaction;

a second identifier for indicating to a calling component whether the component executes within any existing transaction of the calling component; and

a third identifier for indicating to a calling component's container whether the component is called as part of an existing transaction of the calling component.

The first and second identifiers may be merged into a single identifier for indicating whether or not the component requires a transaction. Such software components may be input into a software component assembly tool operable to compare the identifiers of software components against a predetermined set of identifier combinations and if such a combination is identified to be invalid then to indicate an assembly error for the component. The software component assembly tool may be operable to translate the identifiers of software components into transaction attributes of a predetermined application program runtime environment.

Other embodiments provide a method of determining transaction attributes for a transactional software component, the method comprising the steps of:

a) providing a first identifier for indicating whether the component executes in a global or a local transaction;

b) providing a second identifier for indicating to a calling component whether the component executes within any existing transaction of the calling component; and

c) providing a third identifier for indicating to a calling component's container whether the component is called as part of an existing transaction of the calling component.

Steps a) and b) may be used together to provide a single identifier for indicating whether the component executes within an existing transaction of the calling component or requires a new transaction. The method may comprise the further step of comparing the identifiers against a predetermined set of identifier combinations and if such a combination is identified as invalid then indicating an assembly error for the component. The method may comprise the further step of translating the identifiers into transaction attributes of a predetermined application program runtime environment.

Further embodiments provide a software component for assembly with one or more other components into a transactional application program, the software component comprising:

a first identifier indicating whether the component executes within a transaction; and.

a second identifier indicating to a calling component's container whether the component is called as part of an existing transaction of the calling component.

The first identifier may be split into a first part indicating for whether the component executes in a global or a local transaction and a second part for indicating to a calling component whether the component executes within any existing transaction of the calling component.

Other embodiments provide a service component for assembly with one or more other components into a transactional application program, the service component comprising:

a first transaction attribute for providing transaction data for the components container;

a second transaction attribute for providing transaction data to a component's requester; and

a third transaction attribute for providing transaction data for a requester's container.

The first and second transaction attributes are replaced by a single transaction attribute for providing transaction data to a component's container and requester.

Some embodiments provide a software component for assembly with one or more other components into a transactional application program, the software component comprising:

first means for indicating whether said component executes in a global or a local transaction;

second means for indicating to a calling component whether said component executes within any existing transaction of said calling component; and

third means for indicating to a calling component's container whether said component is called as part of an existing transaction of said calling component.

Further embodiments provide a computer program or group of computer programs arranged to enable a computer or group of computers to provide a software component for assembly with one or more other components into a transactional application program, the software component comprising:

a first identifier for indicating whether the component executes in a global or a local transaction;

a second identifier for indicating to a calling component whether the component executes within any existing transaction of the calling component; and

a third identifier for indicating to a calling component's container whether the component is called as part of an existing transaction of the calling component.

Other embodiments provide a computer program or group of computer programs arranged to enable a computer or group of computers to carry out a method of determining transaction attributes for a transactional software component, the method comprising the steps of:

a) providing a first identifier for indicating whether the component executes in a global or a local transaction;

b) providing a second identifier for indicating to a calling component whether the component executes within any existing transaction of the calling component; and

c) providing a third identifier for indicating to a calling component's container whether the component is called as part of an existing transaction of the calling component.

Some embodiments provide a computer program or group of computer programs arranged to enable a computer or group of computers to provide a software component for assembly with one or more other components into a transactional application program, the software component comprising:

first means for indicating whether said component executes in a global or a local transaction;

second means for indicating to a calling component whether said component executes within any existing transaction of said calling component; and

third means for indicating to a calling component's container whether said component is called as part of an existing transaction of said calling component.

### BRIEF DESCRIPTION OF THE DRAWINGS

Embodiments of the invention will now be described, by way of example only, with reference to the accompanying drawings in which:

FIG. 1 is a schematic illustration of a software assembly system for creating applications from software components;

FIG. 2 is a schematic illustration of one of the software components of FIG. 1;

FIG. 3 is a table illustrating elements of the software component of FIG. 2;

FIG. 4 is a flow chart illustrating processing carried out in the system of FIG. 1; and

FIG. 5 is a table illustrating elements of a software component from an alternative embodiment.

### DETAILED DESCRIPTION OF PREFERRED EMBODIMENTS OF THE INVENTION

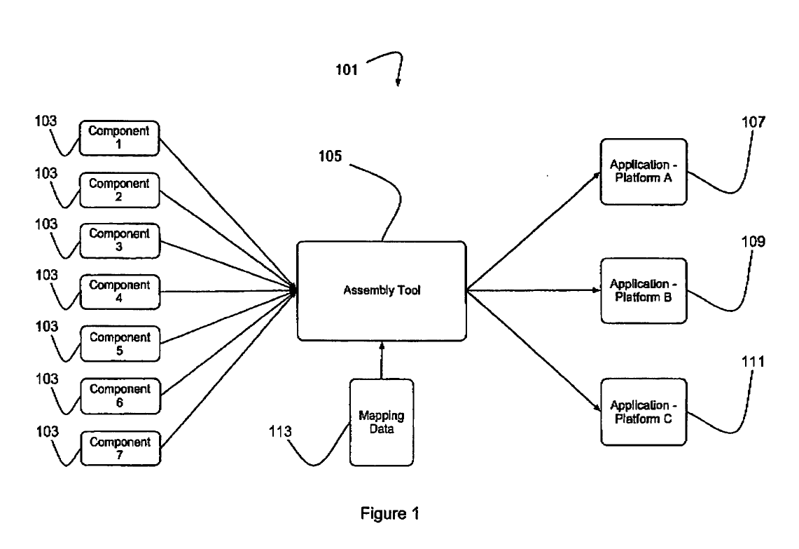

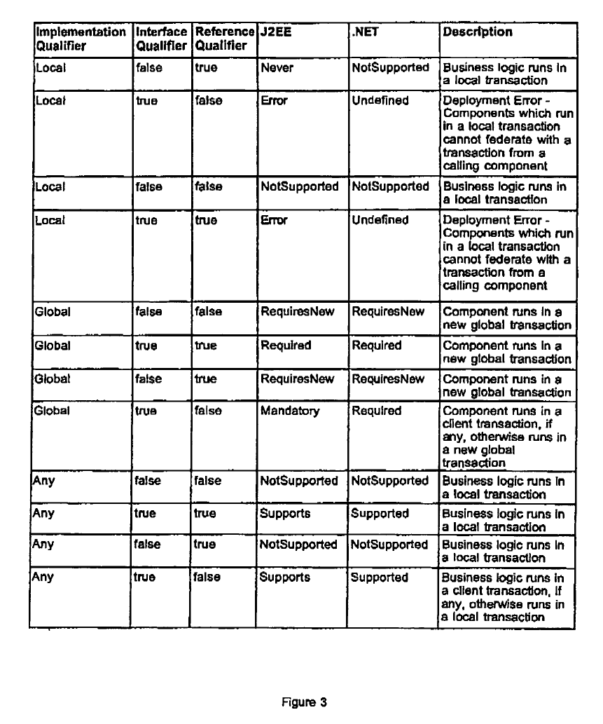

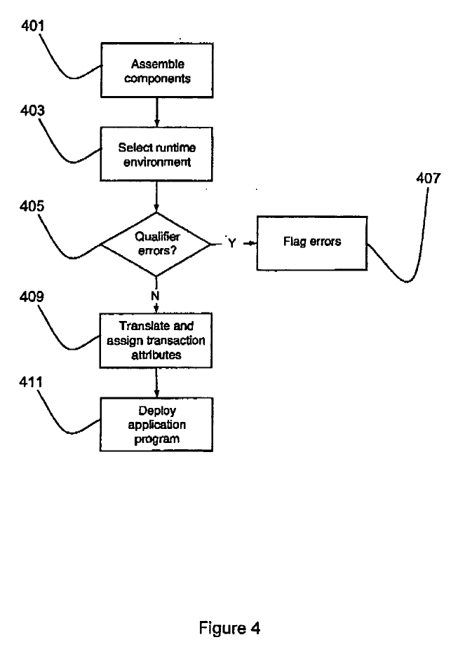

With reference to FIG. 1, a software development environment 101 comprises a set of transactional software components 103 and an application assembly tool 105. The assembly tool 105 takes one or more of the components 103 and assembles them into one or more transactional application programs 107, 109, 111 for running on various target platforms. During the assembly process, the tool 105 carries out checks on the components 103 being assembled to ensure that they have valid combinations of transaction attributes and that the transaction attributes comply with the requirements of the appropriate target platform. Some target platforms may require the transaction attributes to be translated using mapping data 113 and this process will be described in more detail below with reference to FIGS. 3 and 4.

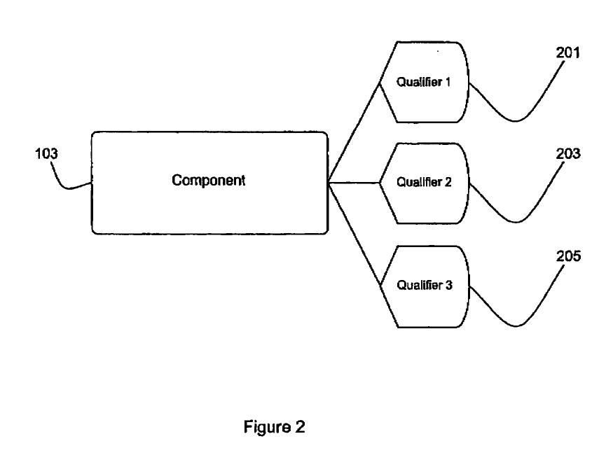

As shown in FIG. 2, each of the software components 103 includes a set of metadata referred to as transaction qualifiers 201, 2 03, 205. The transaction qualifiers 201, 203, 205 qualify the transactional behavior of the software component 103 to which they are attached. Each qualifier is associated with a different perspective of the component and is non-specific to the target platform. The first qualifier 201 specifies what the component's container needs to know, that is, does the component execute in a global or local transaction. The second qualifier 203 specifies what the service component's requester needs to know, that is, will the service component execute in any client transaction. The third qualifier 205 specifies what the container needs to know when this component interact with other components, that is, should the other service component be called as part of a client's transaction. When components are assembled together, the transaction scope of the service component is influenced by all three of the qualifiers.

Transaction Implementation Qualifier

The first qualifier 201 is referred to herein as implementation qualifier and expresses the service component implementation's requirement on its runtime container to dispatch the service component in a specific transaction environment. The valid values for the transaction implementation qualifier are:
Global: there must be an atomic transaction in order to execute this component. The runtime environment must ensure that a global transaction is present before dispatching any method on the component. The runtime environment may use a propagated transaction or may begin and complete a new transaction.
Local (default): the component cannot tolerate an atomic transaction, and will therefore run in a local transaction. A transaction that is propagated to the hosting runtime must not be joined by the hosting runtime on behalf of this component. Local transactions are not propagated outbound across component container boundaries.
Any: the component is agnostic to the presence or absence of a specific transactional environment. The runtime environment will dispatch methods on the component in a global transaction if a global transaction context has been provided by the client or else the runtime environment will establish a local transaction environment prior to dispatching the component.
   Transaction Interface Qualifier

The second qualifier 203 is referred to herein as the transactional interface qualifier which advertises to a requester of the component whether it will join any transaction under which the requester runs. The valid values for the transaction interface qualifier are:
True: the hosting container will join any propagated (client) transaction.
False (default): the hosting container will not join any propagated (client) transaction.
The default value of false aligns semantically with the default value of the implementation transaction qualifier (local).

This qualifier provides no information about the transaction implementation qualifier. The implementation and interface qualifiers are independent but they can be combined to provide familiar J2EE™ and .Net™ transaction declarations as described in further detail below with reference to FIG. 3.

Transaction Reference Qualifier

The third qualifier 205 is referred to herein as the transactional reference qualifier which expresses the service requester's requirement on its runtime container to execute a request to the component within or outside the scope of any transaction associated with the requester. The valid values of the transaction reference qualifier are:
True (default): the methods of the target component invoked using this reference will run as part of any client transaction, but only if the target component also joins any client transaction.
False: the methods of the target component invoked using this reference will not run as part of any client transaction.

The qualifiers 201, 203, 205 can be specified at any time during the development and assembly of the associated component. An assembly of components can be deployed to a supporting runtime environment which may natively understand the qualifiers or an environment which needs the qualifiers to be translated. Examples of environments requiring translation are the .Net™ and J2EE™ environments. In the case of a .Net™ or J2EE™ environment the qualifiers are mapped to equivalent .Net™ and J2EE™ transaction attributes prior to their final deployment in accordance with the mapping data 113.

The table of FIG. 3 shows the mapping data 113 in detail. Each entry in the J2EE™ and .Net™ columns corresponds to the value that is specified by the assembler tool 105 to the runtime environment when deploying the assembled components to that environment. For example, if the three qualifiers specified were:

implementation=global;

interface=false; and

reference=true

then the equivalent in a J2EE™ environment such as WebSphere™ from IBM™ would be an Enterprise Java Bean (EJB) with a transaction attribute of RequiresNew. Similarly in .Net™ deployment environment the component transaction attribute would also be RequiresNew. Some combinations of qualifiers result in undesirable behavior of an assembled application and as such are treated as component assembly or deployment errors. Other combinations of qualifiers result in undefined behavior of the assembled components which may not be desirable depending on the intended function of the assembled application program. Either deployment errors or undefined behaviors are flagged during assembly to enable the appropriate modifications to be made to the assembly of components.

The first three columns of table 3 illustrate how the qualifiers specify transaction requirements in a way which fits with the appropriate roles and responsibilities when the software components are development and assembled. The J2EE™ and .Net™ columns show how the three qualifier model is integrated with existing environments without the need to modify their infrastructure. The qualifiers enable the separation of transaction attribute concerns between the perspective of the service component and the perspective of its consumer, both of which influence the boundary and type of any transaction under which a service component executes. The transaction qualifiers are associated with different perspectives of a service component that are at a level of abstraction above specific deployment environments such as J2EE™ and .Net™. This means that the capabilities and requirements of a service component, deployed in a particular runtime, can be expressed by that component in terms that consumers with different perspectives can understand, including those deployed into a different runtime architecture. The requirements on the component's container is expressed through the implementation qualifier; the capability of the component, with respect to its requesters, is expressed through the interface qualifier; the manner in which the component is used by a requester is expressed through the reference qualifier specified by the requester.

The use of the mapping data 113 by the assembler tool 105 during the assembly and deployment of components will now be described with reference to FIG. 4. At step 401, the components are selected to provide the desired functionality of the application program. The qualifiers for each component may have been supplied prior to this step during the creation of the component or they may be set during the current step. Some components may have an incomplete set of qualifiers. Processing then moves to step 403 where the runtime or execution environment for the application program is selected. Processing then moves to step 405 where the qualifiers for each component are inspected and compared to the entries in the table of FIG. 3.

If any errors are identified, then processing moves to step 407 where the errors are flagged. From the table of FIG. 3, an error occurs when the implementation qualifier is local and the interface qualifier is true (the reference qualifier being irrelevant). This combination of qualifier signifies a deployment error as components which run in a local transaction cannot federate with a transaction from a calling component. If this combination of qualifiers is identified at step 405 then it will be flagged at step 407 to enable modifications to be made to the assembled components to avoid the error.

If at step 405 no errors are detected then processing moves to step 409 where, if the runtime environment is not one to which the three qualifiers 201, 203, 205 are native then the qualifiers are translated into a suitable form. The fourth and fifth columns of the table of FIG. 3 show the translations of each possible qualifier triple into J2EE™ and .Net transaction attributes respectively. The fourth column of the table also provides an explanation of the meaning of each qualifier and its translation in terms of component transactions which is available for consultation by an engineer assembling components in the system. Processing then moves to step 411 where the assembled components are deployed to the target runtime environment.

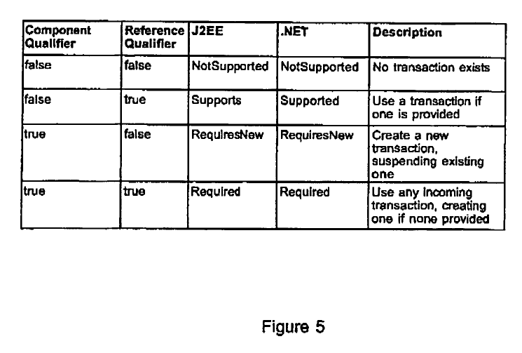

In another embodiment, the implementation and interface qualifiers are merged into a single component qualifier. The reference qualifier retains the same function as described above, that is, it determines whether or not the client of this component will propagate its transaction. In other words would a requesting client require the component to join its transaction. The component qualifier describes whether or not the component requires a transaction. The table of FIG. 5 shows the mapping data for this two qualifier arrangement including the translation of each qualifier tuple into equivalent transaction attributes in the J2EE™ and .Net™ runtime environments. The fifth column of the table of FIG. 5 also includes an explanation of the effect of each qualifier tuple.

Some embodiments provide metadata (in the form of the qualifiers) which declares the scope of transactions from the perspective of both the target service component and its consumer. The metadata is used at runtime to manage the scope of transactions. The system provides a means to express many transactional capabilities and requirements of each component and provides a means to express the transaction metadata of a component in a way that can be consumed by components in the other frameworks. The metadata relates to both the service component implementation and how that implementation is advertised to and influenced by the component requester.

It will be understood by those skilled in the art that the apparatus that embodies a part or all of the present invention may be a general purpose device having software arranged to provide a part or all of an embodiment of the invention. The device could be single device or a group of devices and the software could be a single program or a set of programs. Furthermore, any or all of the software used to implement the invention can be communicated via various transmission or storage means such as computer network, CD-ROM or other suitable storage device so that the software can be loaded onto one or more devices.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. A software component for assembly with one or more other components into a transactional application program, the software component comprising:
a first identifier for indicating whether said software component executes in a global or a local transaction;
a second identifier for indicating to a calling component whether said software component executes within any existing transaction of said calling component; and
a third identifier for indicating to a container of said calling component whether said software component is called as part of an existing transaction of said calling component.

2. A software component according to claim 1 in which said first and second identifiers are merged into a single identifier for indicating whether or not said software component requires a transaction.

3. A software component assembly tool operable to compare the identifiers according to claim 1 against a predetermined set of identifier combinations and if such a combination is identified to be invalid then to indicate an assembly error for said software component.

4. A software component assembly tool operable to translate the identifiers according to claim 1 into transaction attributes of a predetermined application program runtime environment.

5-10. (canceled)

11. A service component for assembly with one or more other components into a transactional application program, the service component comprising:
a first transaction attribute for providing transaction data for a container of said service component;
a second transaction attribute for providing transaction data to a requester of said service component; and
a third transaction attribute for providing transaction data for a container of said requester.

12. A service component according to claim 11 in which the first and second transaction attributes compose a single transaction attribute for providing transaction data to said requester and said container.

13. A software component for assembly with one or more other components into a transactional application program, the software component comprising:
first means for indicating whether said software component executes in a global or a local transaction;
second means for indicating to a calling component whether said software component executes within any existing transaction of said calling component; and
third means for indicating to a container of said calling component whether said software component is called as part of an existing transaction of said calling component.

14. A software component according to claim 13 in which said first and second means compose means for indicating whether or not said software component requires a transaction.

15-18. (canceled)
